(19) United States
(12) Patent Application Publication
(10) Pub. No.: US 2018/0098241 A1
(43) Pub. Date: Apr. 5, 2018

(54) METHOD AND APPARATUS FOR ORDERING OF PROTOCOL DATA UNIT DELIVERY

(71) Applicants: Aaron James CALLARD, Ottawa (CA); Philippe LEROUX, Ottawa (CA)

(72) Inventors: Aaron James CALLARD, Ottawa (CA); Philippe LEROUX, Ottawa (CA)

(73) Assignee: Huawei Technologies Co., Ltd., Shenzhen (CN)

(21) Appl. No.: 15/716,028

(22) Filed: Sep. 26, 2017

Related U.S. Application Data
(60) Provisional application No. 62/402,203, filed on Sep. 30, 2016.

(51) Int. Cl. H04W 28/02; H04W 92/10; H04W 80/06

(52) U.S. Cl. CPC H04W 28/0289; H04W 92/10; H04W 28/0205; H04W 28/0273; H04W 80/06

(57) ABSTRACT

Apparatuses and methods for ordering of protocol data unit delivery are disclosed. According to embodiments, the mitigation of the head-of-the-line blocking is provided by associating an indicator with each of the PDCP packets, which can provide for differentiation of the PDCP packets relating to delivery requirements and/or transmission flows.

### CROSS REFERENCE TO RELATED APPLICATIONS

This application claims the benefit of priority to U.S. Provisional Patent Application Ser. No. 62/402,203 filed on Sep. 30, 2016 and entitled Method and Apparatus for Ordering of Protocol Data Unit Delivery, the contents of which are incorporated by reference.

### FIELD OF THE INVENTION

The present invention pertains to the field communication networks and in particular to methods and apparatuses for ordering of packet delivery or protocol data unit delivery.

### BACKGROUND

According to the Long Term Evolution (LTE) standard established by the Third Generation Partnership Project (3G)), protocol stacks associated with a User Equipment (UE) 105 and an evolved NodeB (eNB) 100 are illustrated in FIG. 1. The protocol layers of a User Equipment include Physical (PHY) Layer 130, Media Access Control (MAC) Layer 128, Radio Link Control (RLC) layer 126, Packet Data Convergence Protocol (PDCP) Layer 124, Radio Resource Control (RRC) Layer 122 and the Non-Access Stratum (NAS) Layer 120. In addition, the protocol layers of an eNB 100 include PHY Layer 118, MAC Layer 116, RLC layer 114, PDCP Layer 112 and the RRC Layer 110.

As can be noted from FIG. 1, a PDCP layer 124, 112 is present in both the UE and the eNB. This layer in the protocol stack sends and receives packets to and from the UE and eNB using an over the air interface. This protocol works along with other Layer 2 (L2) protocols which include the RLC layer and MAC layer protocols. The PDCP layer is responsible for actions including header compression and decompression of IP data, transfer of data, and maintenance of PDCP Sequence Numbers (SNs) among other actions.

In LTE, ordered delivery of the PDCP packets is desired. As such, when PDCP packets are received out of order at the receiver's PDCP layer, they are buffered until they can be delivered in order. The transfer of these packets to a subsequent recipient layer or function, for example Robust Header Compression (RoHC) or other upper protocol layers in the UE, can be inhibited by a head-of-the-line type blocking problem. This blocking problem is particularly apparent when there are multiple transmission flows, and the delivery of data associated with a second transmission flow is impeded because a PDCP packet of a first transmission flow that is received out of order. This can result in a blockage of the delivery of all subsequently received PDCP packets, regardless of which flow the subsequently received packets are intended for until the “missing packet” in the order is delivered.

Therefore there is a need for a method and apparatus for ordering of protocol data unit delivery that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide methods and apparatuses for ordering of packet delivery or protocol data unit delivery. In accordance with an aspect of the present invention, there is provided a method for ordering protocol data unit (PDU) delivery. The method includes inserting, at a packet data convergence protocol (PDCP) layer in a transmitter, an identifier indicative of out of order delivery into the PDU and transmitting the PDU by the transmitter.

According to some embodiments, the identifier is a flow identifier, (flow ID) or a flow ID with an associated set of sequence numbers. In some embodiments, the identifier is a sequence number, wherein a first set of sequence numbers are indicative of in-order delivery and a second set of sequence numbers are indicative of not in-order delivery. In some embodiments, the identifier further includes a sequence number, wherein the sequence number is dependent on the identifier.

According to some embodiments, the method further includes mapping the PDU for delivery to at least one particular data radio bearer (DRB), wherein the at least one particular radio bearer is determined at least in part based on the flow ID.

In accordance with an aspect of the present invention, there is provided an apparatus for ordering protocol data unit (PDU) delivery. The apparatus includes a processor and a memory for storing instructions. The instructions, when executed by the processor cause the apparatus to insert an identifier indicative of out-of-order delivery into the PDU and transmit the PDU.

According to some embodiments, the apparatus is a user equipment (UE). In some embodiments, the apparatus is a base station. In some embodiments, the apparatus is a core network function.

In accordance with an aspect of the present invention, there is provided a method for ordering packet data convergence protocol (PDCP) packet delivery. The method includes receiving, by a receiver, a PDCP packet, wherein the PDCP packet includes an identifier. The method further includes, in accordance with a check of the identifier, forwarding the PDCP packet to an upper layer when the identifier is set as not in-order delivery.

In accordance with an aspect of the present invention, there is provided an apparatus for ordering packet data convergence protocol (PDCP) delivery. The apparatus includes a processor and a memory for storing instructions. The instructions, when executed by the processor configure the apparatus to receive a PDCP packet, wherein the PDCP packet includes an identifier. The instructions, when executed by the processor further configure the apparatus to, in accordance with a check of the identifier, forward the PDCP packet to an upper layer when the identifier is set as not in-order delivery.

According to some embodiments, the apparatus is a user equipment (UE). In some embodiments, the apparatus is a base station. In some embodiments, the apparatus is a core network function.

In accordance with an aspect of the present invention, there is provided a method for ordering protocol data unit delivery. The method includes inserting an identifier into a header of a packet, wherein the identifier is indicative of required in-order packet delivery or required out-of order packet delivery. The method further includes transmitting the packet.

According to some embodiments, the method further includes inserting a sequence number in the header of the packet, wherein the inserted sequence number is dependent on the identifier.

In accordance with another aspect of the present invention, there is provided a method for ordering protocol data unit (PDU) delivery. The method includes inserting a flow identifier into a header of a packet, wherein the flow identifier is indicative of in-order packet delivery or out-of order packet delivery and transmitting the packet.

### BRIEF DESCRIPTION OF THE FIGURES

Further features and advantages of the present invention will become apparent from the following detailed description, taken in combination with the appended drawings, in which:

FIG. 1 illustrates protocol stacks associated with a User Equipment and an evolved NodeB (eNB) in the context of LTE, in accordance with the prior art.

FIG. 2 illustrates a method for ordering packet delivery in accordance with embodiments of the present invention.

FIG. 3 illustrates a method for ordering packet delivery in accordance with embodiments of the present invention.

FIG. 4 illustrates a PDCP header identifying a modification thereto in accordance with embodiments of the present invention.

FIG. 5 illustrates transmitter side behaviour when a flow ID is used to define the packet ordering configuration, in accordance with embodiments of the present invention.

FIG. 6 illustrates transmitter side behaviour when a flow ID is used to define the packet ordering configuration, in accordance with embodiments of the present invention.

FIG. 7 illustrates transmitter side behaviour when a logical channel identifier (LCD) is used to define a flow which defines the packet ordering configuration, in accordance with embodiments of the present invention.

FIG. 8A illustrates a PDCP description in accordance with embodiments of the present invention.

FIG. 8B illustrates a RLC description in accordance with embodiments of the present invention.

FIG. 8C illustrates a MAC description in accordance with embodiments of the present invention.

FIG. 9 illustrates a PDCP feedback packet in accordance with embodiments of the present invention.

FIG. 10 is a schematic diagram of a hardware device in accordance with embodiments of the present invention.

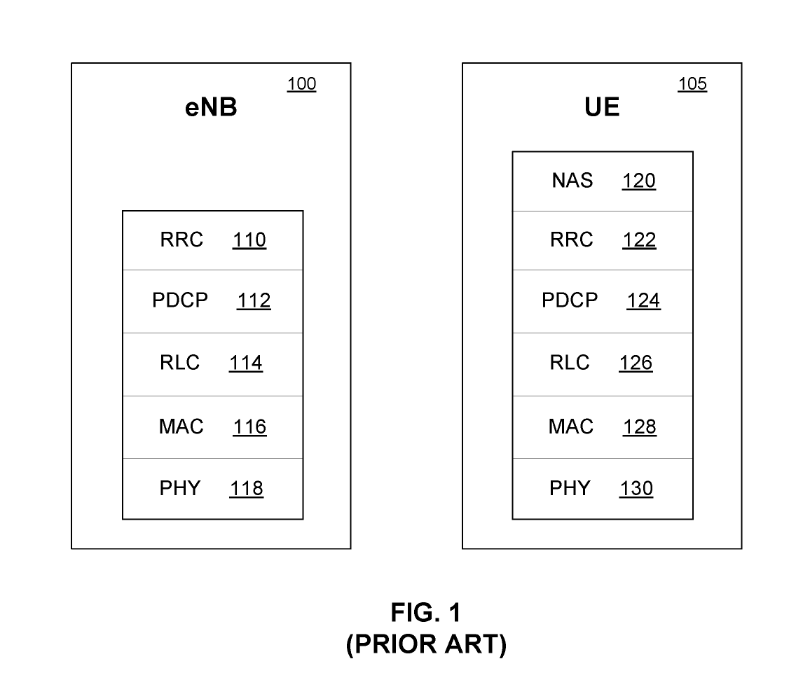

It will be noted that throughout the appended drawings, like features are identified by like reference numerals.

### DETAILED DESCRIPTION OF THE INVENTION

The present invention provides methods and apparatuses, disclosed and described herein, that can be used for ordering of protocol data unit delivery. According to embodiments of the present invention, there are provided methods and apparatuses that can mitigate head-of-the-line blocking of the subsequent delivery of PDCP packets when these packets are received out of order during interaction between a user equipment and a radio access node. According to embodiments, the mitigation of the head-of-the-line blocking is provided by associating an indicator with each of the PDCP packets, which can provide for differentiation of the PDCP packets relating to delivery requirements and/or transmission flows. The indicator may also be referred to as an identifier.

It will also be readily understood that out-of-order is synonymous with and equivalent to not in-order and as such these terms can be used interchangeably. For example, out-of-order delivery can equally and interchangeably be called not in-order delivery. It will also be understood that an indicator that in order delivery is required may be implemented as not indicating that out of order delivery is allowed.

According to embodiments of the present invention, the mitigation of the head-of-the-line blocking is provided by associating an identifier with each of the PDCP packets (also referred to as PDCP Protocol Data Units (PDUs)). The identifier can be used to identify if a PDCP packet requires in-order delivery. As such, a PDCP packet having an identifier that specifies that in-order delivery is not required, can be delivered upon receipt. A PDCP packet having an identifier that specifies that in-order delivery is required, will only be delivered upon receipt of the PDCP packet with the previous sequence number (SN). This allows for flexibility, and provides a worst case scenario that is no different than the existing art.

According to embodiments of the present invention, the mitigation of the head-of-the-line blocking is provided by associating an indicator to identify if a PDCP packet requires in-order delivery and a sequence number (SN) that is specific to the indicator. Accordingly, a first set of sequence numbers are used to identify the sequence of PDCP packets that require in-order delivery and a second set of sequence numbers are used to identify PDCP packets that do not require in-order delivery. In this embodiment, out of order receipt of PDCP packets that require in-order delivery will not impede the delivery of the PDCP packets that do not require in-order delivery.

Those skilled in the art will appreciate that in a conventional implementation, when a two different traffic flows are part of the same PDCP flow, a missing PDCP PDU associated with the first traffic flow will result in the PDCP layer buffering all other data in the PDCP flow until the missing PDCP PDU is either received, or a timeout occurs. While this is happening, it is possible that all the PDCP PDUs associated with the second traffic flow have been arriving in order. The PDCP PDUs associated with the second traffic flow could have been delivered in order, but instead have been blocked by the missing PDCP PDU in the first traffic flow. Embodiments of the present invention allows for an indicator to be added to the PDCP PDUs that allows a PDCP function or layer to differentiate between the traffic flows within the PDCP traffic. This can be used to provide in-order delivery of PDCP PDUs for each traffic flow, even if it results in an overall out of order delivery of the entire PDCP PDU stream.

According to embodiments of the present invention, the mitigation of the head-of-the-line blocking is provided by associating an indicator to identify the transmission flow with which the PDCP packet is associated. In this configuration, each of the transmission flows has an associated set of sequence numbers. As such, the ordering of a first transmission control protocol (TCP) flow has little relevance to the ordering of a second TCP flow. The indicator may be an indicator of a transmission flow identity, or other such identifier.

It will be readily understood that while many of the embodiments discussed herein make reference to the PDCP layer, it will be readily understood that the discussion can at least equally be applied to other protocol layers provided that the other protocol layers have a similar functionality. For example the RLC layer has at least some similarities to the PDCP layer and thus this discussion may at least in part apply to this layer as well.

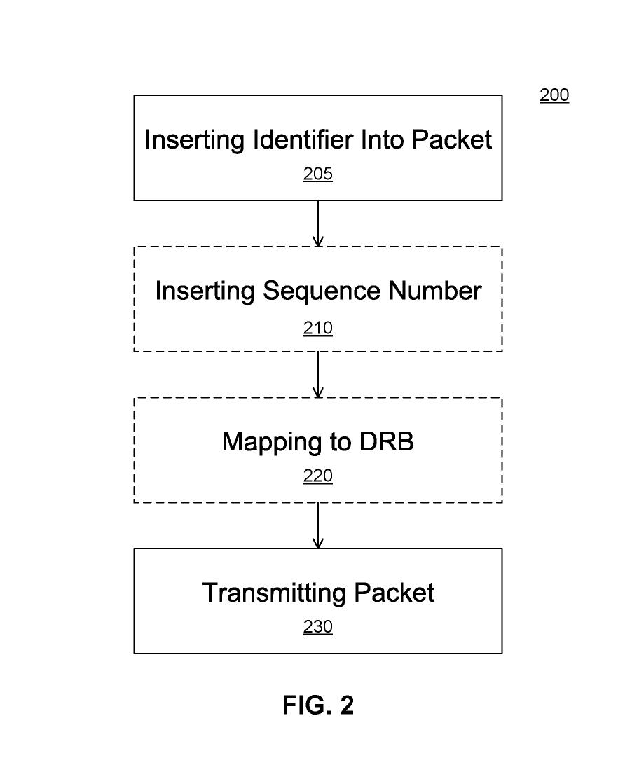

FIG. 2 illustrates a method for ordering packet delivery in accordance with embodiments of the present invention, wherein the method is performed from the perspective of the transmitter. It would be readily understood that the transmitter can be associated with the user equipment (UE), or the base station, for example a NodeB, an evolved Node B (eNodeB, or eNB), a next generation NodeB (sometimes referred to as a gNodeB or gNB) or other base station configuration. Further, the transmitter can be associated with a Core Network function having associated therewith a network interface for receiving data from and transmitting data to network functions connected to a network.

As illustrated in FIG. 2, the method 200 includes inserting 205 an indicator or identifier into the packet for delivery. In an embodiment, the identifier is indicative of whether the packet is to be delivered in-order or not in-order. In an embodiment, the identifier is used to identify the PDCP PDU with an associated the transmission flow, this identifier can be configured as a flow identifier or a flow ID. In some embodiments, the indicator is a sequence number, wherein a first set of sequence numbers are indicative of in-order delivery and a second set of sequence numbers are indicative of not in-order delivery. The first and second sets of numbers may be defined as numbers being on opposite sides of a threshold level. The method further includes the transmitter transmitting 230 the packet. In some embodiments, the method further includes inserting 210 a sequence number into the packet, wherein the sequence number (SN) that is specific to the inserted identifier.

With further reference to FIG. 2, in some embodiments, the method further includes mapping 220 the PDCP PDU to a particular data radio bearer (DRB). In this embodiment, there are provided multiple DRBs, wherein at least one of the DRBs is configured to provide not in-order delivery of the packets.

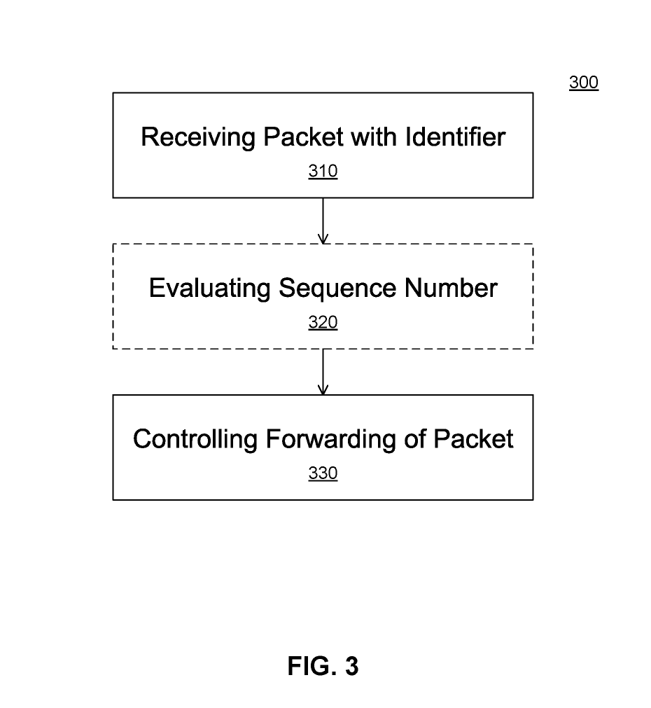

FIG. 3 illustrates a method 300 for ordering packet delivery in accordance with embodiments of the present invention, wherein the method is performed from the perspective of the receiver. The receiver can be associated with the user equipment (UE), or the base station, for example a NodeB, an evolved Node B (eNodeB, or eNB), a next generation NodeB (sometimes referred to as a 5G NodeB, gNodeB or gNB) or other base station confirmation. Further the receiver can be associated with a Core Network function having associated therewith a network interface for receiving data from and transmitting data to network functions connected to a network.

As illustrated in FIG. 3, the method 300 includes receiving 310 a packet, or PDCP PDU, with an identifier, wherein the identifier is indicative of whether the packet is to be delivered in-order or not in-order. The method further includes controlling forwarding of the packet by the receiver, wherein controlling forwarding is based on the identifier. For example, in some instances controlling forwarding includes immediately forwarding the packet when the identifier is indicative of not in-order delivery. In some embodiments, the method further includes evaluating 320 the sequence number associated with the PDU (and typically specified within the header). For example, the received packet can include an associated sequence number and controlling forwarding includes delaying forwarding of the packet when the identifier is indicative of in-order delivery and a packet with a previous sequence number has not received by the receiver.

When packets include an identifier which is indicative of not in-order delivery, forwarding includes immediately forwarding the packet and as such this may be considered to be similar to the use of forwarding timer, wherein the forwarding timer is set to substantially zero. This forwarding timer may be considered a reordering timer which defines a length of time a device, e.g. the UE, base station or core network function, waits before delivery of a packet when that packet is received out of order, for example with respect to the sequence number thereof.

Further discussion of configurations of an identifier associated with one or more packets is defined below. It is readily understood that these configurations are not be considered as limiting, however merely illustrating options for the identifier that can be configured to define in-order delivery or not in-order delivery in accordance with embodiments of the present invention.

### Ordering Based Solely on Indicator

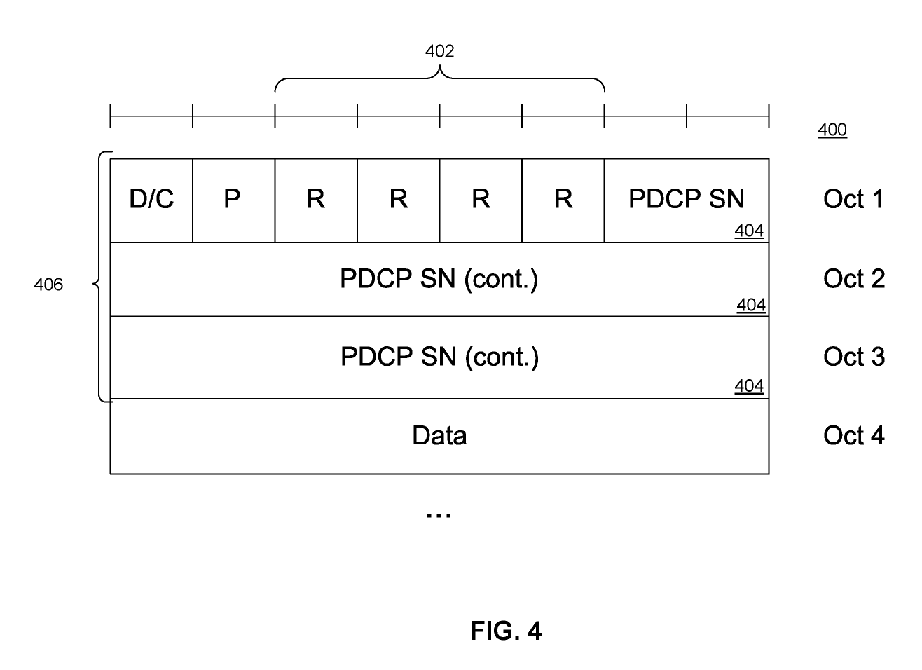

FIG. 4 illustrates a PDCP PDU 400, having a header 406, identifying a modification thereto in accordance with embodiments of the present invention. According to embodiments, the mitigation of the head-of-the-line blocking is provided by associating an indicator with each of the PDCP packets, which can provide for differentiation of the PDCP packets relating to delivery requirements. The identifier can be configured as a single bit that is provided in every PDCP packet, for example a PDCP-PDU packet, indicating if this packet requires in-order delivery or not, namely out-of-order delivery. According to embodiments, one of the reserved bits (R) 402 (identified in FIG. 4 by the parenthesis), can be used to transfer this information. However, according to other embodiments, the identifier may be located elsewhere within the PDCP header or other element of the PDCP packet. According to embodiments, the sequence number (SN) 404 is associated with the PDCP packet and can be used for retransmission purposes, for example when packet loss occurs. It should be understood that FIG. 4 illustrates just one of several options for the integration of the identifier into the PDCP header 400. It will be readily apparent that different options can use different bits associated with the PDCP in order to convey the identifier.

According to embodiments, the PDCP packet is recovered at the receiver, the identifier is checked and the packet is forwarded to the upper layers immediately if the in-order delivery bit flag, namely the identifier, is set negatively. If the identifier is set as true, then the packet is only forwarded to upper layers if the previous SN with the in-order delivery bit set as true has been received. However, according to this embodiment, it is noted that in this scenario any PDCP packets that are missing, must be presumed to contain the in-order delivery bit (identifier) set as being true.

According to embodiments, a consequence of this configuration of the identifier is that packets required to be delivered in order may suffer unneeded latency as these packets are held until the packet with the previous sequence number is received, regardless as to whether the previous packet required in-order delivery. This latency is no greater than the latency introduced in existing PDCP methods where in-order delivery is required for all packets within a radio bearer. However, this delay may not be mitigated by this any or all embodiments. One possible advantage of this embodiment is that when packets do not require in-order delivery and are correctly received these packets do not suffer unnecessary delays at the receiving PDCP layer. It is understood that according to this embodiment, the feedback to the transmitter is not changed as this feedback relies on only one series of sequence numbers.

### Ordering Based on Indicator and Sequence Number

According to embodiments of the present invention, the mitigation of the head-of-the-line blocking is provided by associating an indicator to identify if a PDCP packet requires in-order delivery as well as including a sequence number (SN) 404 that is specific to the indicator. For example, packets requiring in-order delivery have a first set of sequence numbers associated therewith, while packets not requiring in-order deliver have a second set of sequence number associate therewith. According to embodiments, a single bit is included in each PDCP packet, indicating “in-order” or “not in-order” delivery, and the sequence number associated with the packets are assigned based on the identifier. In this way when a packet is missing which is designated as “not in-order”, this missing packet will not cause a head-of-line blocking of the “in-order” packets. According to embodiments, one of the reserved bits (R) 402 (identified in FIG. 4 by the parenthesis), can be used as the identifier indicating in-order or not-in-order.

According to embodiments, the sequence numbers associated with the in-order packets can be configured to have an independent or orthogonal SN space. In addition, according to this embodiment, the feedback to the transmitter which is required for retransmission of missing packets will include an identification of the identifier indicating if the missing packet was assigned as being an in-order or out-of-order packet as well as an indication of the sequence number of the missing packet. Processes which use this SN, for example encryption and decryption, may additionally use this indicator bit to differentiate the different PDUs.

In some embodiments, the indicator specifying the requirement for in-order delivery or the acceptability of out-of-order delivery can be inferred from the SN. For example, in some embodiments even numbered SNs can be associated with a requirement for in-order delivery, while odd numbered SNs can be associated with not requiring in-order delivery. As would be readily understood, other sequencing configurations of SNs that can be separated to define in-order delivery or out-of-order delivery can be used.

For example, a first set of sequence numbers is indicative of in-order delivery and a second set of sequence numbers is indicative of not in-order delivery. In another embodiment, the SNs associated with in-order delivery may be a consecutive set of SNs, while the SNs associated with out of order delivery may be a distinct consecutive set.

### Ordering Based on Flow

According to embodiments of the present invention, the mitigation of the head-of-the-line blocking is provided by associating an indicator to identify the transmission flow with which the PDCP packet is associated. In this configuration, each of the transmission flows has an associated set of sequence numbers.

The transmission flow discussed above may take the form of a flow identifier or flow ID. It will be readily understood that by using a flow ID there may an inherent quality of service that is required for the particular flow, as such in some instances the flow ID may be considered synonymous with or defined as a quality of service flow ID, e.g. QoS flow ID.

According to embodiments, upper layer in-order delivery only matters within a particular flow. For example, the ordering of one TCP flow has little relevance to the ordering of another TCP flow. Accordingly, in order to provide this differentiation, according to embodiments, a “flow ID” field can be used within the PDCP layer. According to embodiments, each flow ID field has its own set of SN and the ordering of the receipt of packets is enforced based on the flow ID and the associated SN. According to embodiments, control signalling is based upon this combination of flow ID and SN fields and accordingly feedback regarding receipt of packets would contain multiple elements relating to the specific flow and the SN associate with that specific flow.

According to embodiments, the flow fields, for example the context ID (CID) from the Robust Header Compression (RoHC) can be used to define the flow ID. If the RoHC CID field is used, then the CID does not imply whether in-order is required or not. Accordingly, in some embodiments, when the CID is used to convey the flow ID, an additional bit, for example one of the reserved bits discussed above can be used to convey if in-order delivery is required for the particular flow ID. Because the CID field is typically encrypted, this field can be moved/copied out of the RoHC header and into the outer protocol header (PDCP), for example. In another embodiment, the receiver can be aware of a semi-static assignment of particular flow IDs (which may be defined by the RoHC CID field) as requiring in-order delivery. The receiver can identify the relevant flow IDs by use a semi-static lookup table, as would be readily understood. In another embodiment, the receiver is aware, for example by use of a lookup table or the like, of a predefined set of flow IDs (which are defined by the RoHC CID field) that require in-order delivery. According to embodiments, one of the flow IDs can refer to all flows which do not require in-order delivery. According to other embodiments, the type of ordering for a given flow ID is configured by explicit control signalling.

In other embodiments the flow ID field is not directly connected to the CID and can be determined separately. The flow ID may be carried in one or more of the reserved bits (R) 402, for example with reference to FIG. 4, or additional space may be assigned to these bits reserved bits.

In other embodiments, the flow ID can be obtained solely from the SN using for example a modulo function of N, where N is the number of identified flows. For example, N can be predefined and limited or dynamically configured by control signalling. The out-of-order flow can be predefined to be one or more flows, or each flow can be dynamically set as in-order or out-of-order by control signalling.

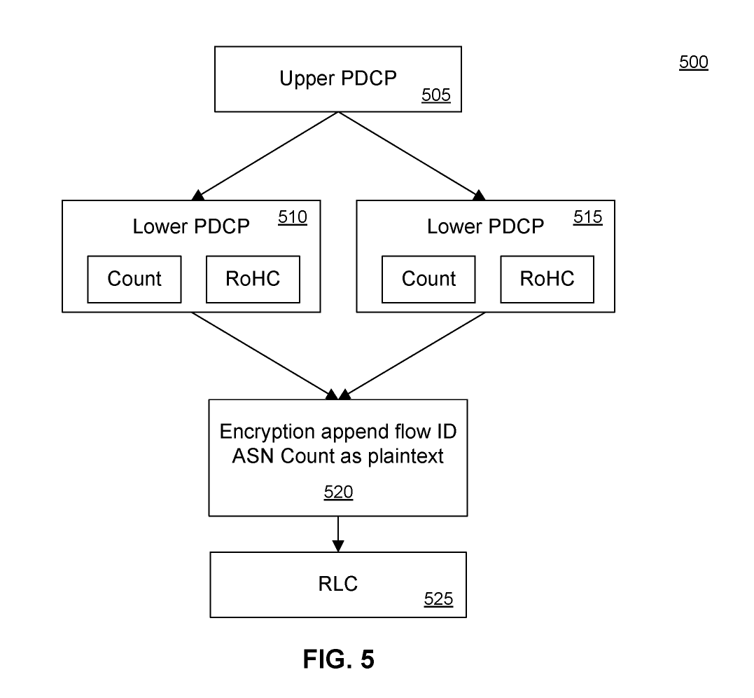

FIG. 5 illustrates transmitter side behaviour 500 when a flow ID is to define the packet ordering configuration, in accordance with embodiments of the present invention. In this figure, the actions performed at the PDCP layer can be defined by an upper PDCP function 505 and a lower PDCP function 510, 515 followed by an encryption function 520 and subsequent delivery to the RLC layer 525. On the downlink (DL), the upper PDCP function 505 can perform flow identification based on the flow ID, and subsequently pass the packet to the particular lower PDCP function 510, 515 that is associated with that particular flow ID. It will be readily understood that while FIG. 5 illustrates only two lower PDCP functions 510, 515, more PDCP functions can be present and the number of PDCP functions implemented can be directly dependent on the number of flow IDs being assigned to the packets. Upon receipt of the packet at the lower PDCP function 515, 510, RoHC can be performed and the flow ID for example in abstract syntax notation (ASN) and the count in plain text. It should be understood that the upper PDCP layer may merely examine the incoming PDUs in order to determine the flow ID for provision to the appropriate lower PDCP layer.

Either or both of the Flow ID and the count can be added during the encryption procedures 520. The result of the encryption procedure 520 either with or without either or both of the Flow ID and count, can be forwarded to the RLC layer function 525.

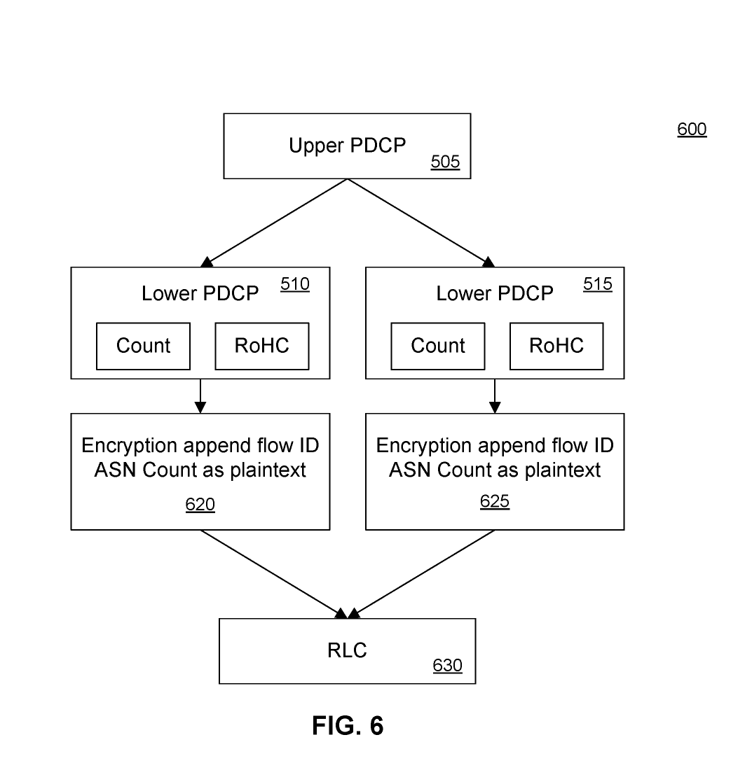

In some embodiments 600, as illustrated in FIG. 6, the encryption step 620, 625 can be performed in parallel for each of the respective flow IDs and the resulting packets can converge at the RLC layer 630.

As illustrated in the embodiment 600 of FIG. 6, the Upper PDCP 505 and Lower PDCP 510 and 515 division can be maintained. This allows for different processing chains for the different flow IDs. As noted, the encryption procedure 520 of FIG. 5 can be split up into parallel encryption procedures 620 and 625, which both provide their output (typically a PDCP PDU) to the RLC layer 630.

It would be readily understood that on the receive side, for example, in an uplink (UL) scenario, the actions identified in FIGS. 5 and 6 would be reversed, (for example encryption would become decryption) and the arrows illustrated in these figures would point in the opposite direction. In some embodiments, the Count determination (for example the count Box) function can become the function in charge of in-order delivery. It is noted that one or more of the flow IDs may be representative of the flow not requiring in-order delivery. The reversal of the arrows, would result in the previously discussed reverse processes being performed in the reverse order, so that where the transmitter side process would start with the receipt of a PDCP SDU, the receiver side process would start with the reception of a PDCP PDU and end with the generation of a PDCP SDU.

### Relative Dependency

According to embodiments, rather than specifically defining which flow ID requires in-order delivery, one field is used to inform that a first PDU has a relative dependence on a previous PDU. According to embodiments, x bits transmitted in the PDU can be used to indicate the value X in the range of [0, 2^{x}−1], which can be used to define a relative dependency of the PDUs. For example, the relative dependency of the current PDU SN can be with (current PDU SN−X). This can be used to inform the receiver that this packet should effectively not be processed until the PDU with sequence number SN−X is processed. According to embodiments, the identification of the relative dependency, for example the value X, can be implemented within the RLC layer or the PDCP layer. At the RLC layer the RLC SN can be used.

As an example, if for a particular flow, a protocol layer knows which packets have been received and that all previous PDU packets have been acknowledged, the transmitter is free to indicate that the next PDU of that flow does not depend on any previous PDUs and thus X=0. However, if some packets have not been acknowledged, then X can be determined as being equivalent to the difference between the SN of the last acknowledged packet and the SN of the currently transmitted PDU packet.

According to embodiments, relative dependency can be used at the RLC layer as there is likely never be a dependency (i.e. relative to a packet which is not already acknowledged) more than a fixed number of transmissions before the currently received packet. Accordingly, in this embodiment the RLC sequence number can limit X to a small value, for example 3 bits which can define a dependency of up to 8 transmission time intervals (TTI) before the currently received packet.

According to embodiments, a scheduler is configured be aware of label marking, for example the scheduler can be configured to provide data to a receiver wherein the data is indicative of a dependency of a current transmission on a previous transmission.

According to embodiments, the scheduler receives information from the transmitting RLC layer that one transmission contains data requiring ordering. For simplicity of this example, consider two differentiated flows, one ordered and one not and thus at each TTI granted, the scheduler transmits one bit of information regarding whether that grant contains data that is ordered data or not. Furthermore, the scheduler can keep track of acknowledged transmissions such that the scheduler knows that any previous transmissions are one of: 1) delivered; or 2) either potentially delivered but unacknowledged or failed to be received correctly and not yet retransmitted. When these two sets of information are combined, the scheduler can determine whether the next transmission containing ordered data is dependent on a previously ordered data transmission that is either not acknowledged yet or failed. The scheduler can therefore inform the receiver that the current transmission is dependent on a previous transmission, and the relative dependency can be determined by determining relative TTI of that transmission, for example by counting TTIs as previously discussed with respect to the determination of relative dependency. The receiving RLC layer can subsequently wait on re-transmissions accordingly, for example until the transmission upon which the current transmission relatively depends.

According to embodiments, depending on the design of the RLC layer, the RLC SN may or may not loosely coordinate with TTI transmissions or previous transmissions, for example if the SN is not incremented when multiple PDU's are in the same TTI.

According to embodiments, messaging of relative dependency by the scheduler is not indicated in accordance with a per TTI/grant basis, but in accordance to a Logical Channel ID (LCID)/RLC, or PDCP sequence. The scheduler provides a message that indicates whether to process immediately or indicates the protocol layer and ID upon which the receiving side is to wait. This indication by the scheduler can be done on the per PDCP layer or on the per RLC layer. In addition, as concatenation can occur at either the RLC layer or the MAC layer, both of these layers can be supported by having a field in the acknowledged mode (AM) PDU header which indicates the relative dependency of this group of PDU's on other RLC PDUs. According to embodiments, the field of the AM PDU header can be delta encoded with the SN field in the RLC header, and indicate what the SN of the RLC upon which it depends. To indicate multiple RLC header dependencies, multiple RLC PDUs can be generated in the same TTI, with each using a different RLC header.

### RLC Layer Indication

According to embodiments, the RLC packet header can include an indicator that is used to indicate dependency of a current RLC transmission on other RLC transmissions. The indicator can be configured using one or more of the reserved bits in the RLC header or the indicator may be configured by adding an additional field of one or more bits of the RLC header resulting in the current bits of the RLC header being shifted. According to embodiments, the indicator is defined in the new field termed a FL field which can be transparently determined from upper layer signalling. Alternately, the FL field can be determined directly if re-ordering of the received packets is also indicated at the PDCP layer. This information/field may be stripped from the PDCP layer header for over-the-air transmission in this case and recreated from the RLC FL field.

According to embodiments, the FL field indicates which RLC SN the current series of PDCP PDU's depend on. This RLC SN may or may not be delta encoded with the current SN. The RLC layer at the receiving side, can be configured to check the FL field. If the SN indicated in the FL field has already been processed, then all attached and completely received PDPC PDUs (which are contained in the data field of an AM PDU, may be further processed. Otherwise this data must be buffered for later processing. It is noted that for early decryption of PDCP this action may be done at this time. Optionally the PDCPs can be marked for the upper protocol layer to be aware of the requirement of ordered delivery and to which flow the PDCPs belong. In the instance where the RLC and PDPC are not co-located, this awareness may be provided to the upper protocol layers by an identifier associated with an upper layer RLC SN, which indicates the order in which traffic is be processed/transmitted. According to this embodiment, the transmission of acknowledgements and negative-acknowledgements will not require any modification.

### MAC Layer Indication

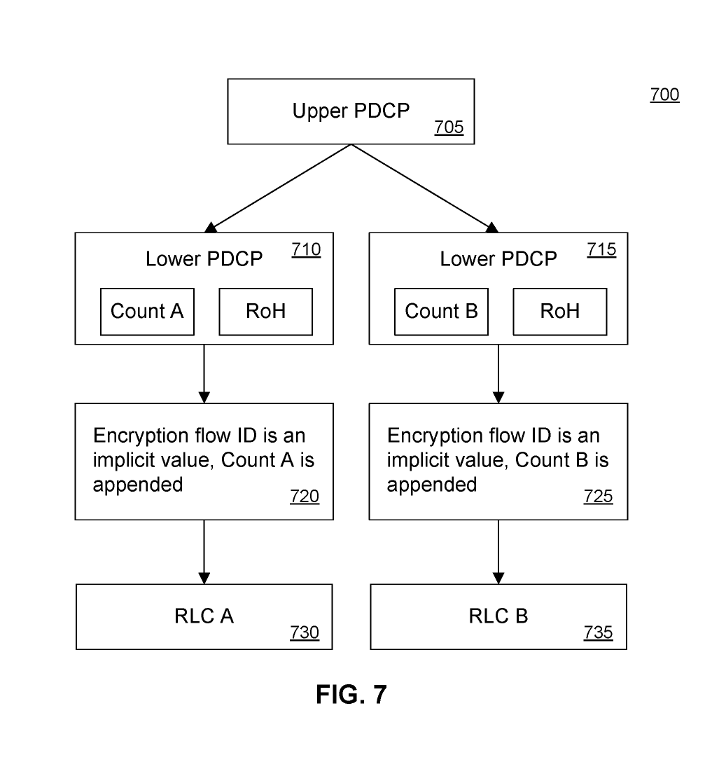

It is known that the MAC layer multiplexes many different channels, identified by LCID values. According to embodiments, on the receiver side flows can be differentiated by LCIDs and, as such, MAC information can be used to differentiate flows. In some embodiments, the stack is not changed and each LCID/flow is mapped to separate PDCP, which can represent different radio bearers (RB). In some embodiments, the LCIDs are mapped to one PDCP function, for example the upper PDCP 705 illustrated in FIG. 7. According to embodiments, one of the LCIDs may be configured or defined to not support reordering of delivery. According to embodiments, in this configuration, the RLC FL field or the PDCP Flow ID can be implicitly determined based on the LCID that is used in the MAC layer.

In some embodiments, the multiple LCIDs can correspond to a single radio bearer. This single radio bearer may be mapped to a single PDCP, and may be seen as a single bearer from the perspective of the core network (CN) and control channel signalling.

According to embodiments, one session key and one radio bearer are required. The mapping of individual PDCP PDUs to the LCID can be indicated over the PDCP/RLC split. According to embodiments, the mapping can be configured by referring to the RLC/MAC mapping. For example, at the MAC layer a 1-bit field can be added indicate that the SN in the following PDUs has been stripped or removed and should be assumed to be equal to one larger than the SN in the last PDU with the same LCID. At the RLC layer, for example many different PDCP PDUs are concatenated together and a single SN can be appended to the RLC header.

According to embodiments, there is a one to one mapping of RLC layers to LCIDs and feedback on an LCID is not changed, for example each RLCs feedback buffers. The PDCP 700 can be split into one upper PDCP layer 705 and multiple lower PDCP layers 710, 715, each applying to a separate SN. This configuration is illustrated in FIG. 7 which illustrates transmitter side behaviour when a LCID is used to define a flow which defines the packet ordering configuration, in accordance with embodiments of the present invention. The encryption 720, 725 would use the flow ID implicitly. According to embodiments, this can be performed by having the session keys different for different lower PDCP, or by expanding the count field used in encryption to include the flow D.

After encryption 720, 725, each packet can be forwarded to their respective RLC layer, e.g. RLC A 730 or RLC B 735.

According to embodiments, the LCIDs are mapped to one RLC layer and a joint feedback is provided. The PDCP/RLC layers can transparently receive the LCID information in order to know on which service data units (SDUs) reordering is to be applied.

It is noted that the above defines different ways that various layers can interact to provide awareness to the layers relating to flow identification and the requirement of reordering of packets. According to embodiments, these interactions can be in a manner in which different layers can join or separate at different key points. During the creation of such a radio bearer there is a new mapping of data defined between the MAC and PDCP layers. In particular, the MAC is informed of LCIDs mapped to the same PDCP/DRB such that it multiplexes these without strict priority. In this embodiment, one or more of the following aspects can apply.

In some embodiments, a first aspect relates to buffer reports. For example, if multiple LCIDs contain information which essentially has the same priority, then it does not necessarily make sense to differentiate the data in the buffer reports. Therefore in this embodiment the buffer status reports (BSR) may only refer to the summation over groups of LCIDs, wherein this grouping can be configured by RRC signalling.

In some embodiments, a second aspect relates to the PDCP layer. For example, the LCID mapping to the lower PDCP layer (as illustrated in FIG. 7) can be joined above the RLC layer and thus the same encryption keys, or keys that have been derived or exchanged jointly can be used.

In some embodiments, a third aspect relates to RoHC. For example it can be desirable to map multiple LCIDs to the same RoHC. This mapping corresponds to moving the RoHC as illustrated in FIG. 7 into the upper PDCP layer. This mapping may reduce the context maintenance of the RoHC layer.

In some embodiments, a fourth aspect relates to the PDCP SN. For example, multiple PDCPs can use the same sequence number, and thus PDCP feedback related to this sequence number is shared across the LCIDs.

In some embodiments, a fifth aspect relates to the RLC SN. For example, multiple RLCs can use the same sequence number, and thus RLC feedback related to this sequence number is shared across the LCIDs.

According to embodiments, a modification of a current configuration associated with an LTE compliant implementation, can be provided wherein when at least two data radio bearers (DRBs) are configured, at least one of these radio bearers is configured to not apply in-order delivery. In this embodiment, different traffic flow templates (TFTs) are assigned to each radio bearer in order to differentiate delivery requirements. In one embodiment, the Core Network can split the flows, for example into in-order flows, not-in-order flows, and the TFTs can map tunnel endpoint identifiers (TEIDs) to adequate DRBs. In another embodiment, the TFTs can be used to define user datagram protocol (UDP) traffic to the not-in-order DRB and, transmission control protocol (TCP) to the in-order DRB. In embodiments, the setup of radio bearers additionally provides information on the prioritization or fairness to apply in between these DRBs.

It will be understood that the packet or flow can be mapped for delivery to at least one particular data radio bearer (DRB), wherein this at least one DRB is configured to provide either in-order delivery or not in-order delivery. Accordingly, the flow ID can be used to determine the at least one particular DRB.

According to some embodiments, the mapping of traffic flows can be defined by the UE in the uplink direction and defined by the radio access node (eg. an eNodeB) in the downlink direction. According to some embodiments, mapping rules can be provided. According to some embodiments, mapping rules can be embedded in the general packet radio service (GPRS) tunnelling protocol (GTP-U) header. For example, the mapping rules can be directed to mirroring of mapping of traffic flows, (e.g. traffic flows defined by a particular flow ID). In this example, in the uplink direction, when the UE acts as the transmitter, the UE can map the uplink packet for delivery such that this mapping is at least in part dependent on the mapping of previously received downlink packet. As another example, in the downlink direction, when the base station (e.g. eNB or gNB) acts as the transmitter, the base station can map the downlink packet for delivery such that this mapping is at least in part dependent on the mapping of previously received uplink packet. It would be readily understood that the mapping of a previously received downlink packet is equivalent to a known mapping of an downlink packet and in the opposite transmission direction, the mapping of a previously received uplink packet is equivalent to a known mapping of an uplink packet.

According to embodiments, a protocol description for the MAC/RLC/PDCP protocol layers is defined below. According to embodiments, the transmission side protocol is defined as shown in TABLE 1. According to embodiments, it is presumed that the protocol includes a flow based differentiation, that there is one SN per flow, that the RLC layer uses SN based encryption and that there is concatenation in the RLC/MAC layers. It is also noted that in the tables below, items that are identified in italics are considered to be optional.

TABLE 1

| Step | Info Used | Info. added | Header Modified |
|---|---|---|---|
| 1) Classification | NG-U | Flow ID, DRB ID | |
| 2) RoHC | IP header | RoHC | Strips IP header |
| 3) Add SN | Flow ID, | SN, Fragment | |
| | DRB ID | Number | |
| 4) Encryption | SN, RB, | | RoHC and Data |
| | Flow ID | | |
| RLC/MAC | | | |
| 5) SN compression | SN | First SN in | Strip SN in |
| | | consecutive | consecutive |
| | | sequence. | sequences |
| 6) Concatenate | Lengths | Lengths (L1, | |
| | | L2, . . . ) | |
| 7) Segmentation | MAC size | Frame indicator | |
| | available | (FI) | |
| 8) Multiplex | DRB ID | LCID | Strip DRB ID |

According to embodiments, it is presumed that before PDU transmission the following parameters have been initialized, session keys, RoHC type, initial SN, classification scheme and LCD mapping.

According to embodiments, the order of the actions can be modified provided that the effective end result is provided. With reference to TABLE 1, by reading the NG-U header the packet is classified into flow and DRB ID; within a flow and data radio bearer (DRB) an individual RoHC instance exists and the RoHC is applied as configured for the RB; a unique SN is appended to each PDU, wherein the SN is incremented after every PDU; and encryption is applied to the RoHC and data fields, as part of the cipher key the RB ID (DRB#), the flow ID and the SN is used.

According to embodiments, the RLC/MAC is responsible for multiplexing, concatenation and segmentation, and providing the packets effectively unmodified to the over the air link. It is understood that changes may be made to the packets, however this is to be performed over the air link.

According to embodiments, the RLC/MAC layers perform SN compression, wherein all PDUs with sequential SN (and same flow/RB ID) transmitted within the same TTI are concatenated together. The PDCP SN is dropped and moved to the RLC SN field. Compression of the RLC SN field may be performed (dropping MSB's) if configured. If segmentation occurs then a fragment number can be appended to (or otherwise added to) the header. This fragmentation number is typically initialized with a starting value of 0 for the first time a particular PDCP PDU is segmented. The fragmentation number is incremented each time it is used and can be configured to wrap around if the fragmentation number exceeds the allocated counting space. If the first PDCP PDU is segmented, the RLC SN is set to that fragmented SN. The RLC/MAC layers subsequently perform concatenation/segmentation, wherein given a total length field L_{T} from lower layers, the RLC determines how many PDUs it can transmit, i.e. find N the largest N s.t. Σᵢ^{N} Lᵢ≦L_{T}. The first N length fields are sent (L₁, L₂, . . . , L_{N}) in the RLC header. The final PDU can have the length field determined from the lower layer length fields. Frame indicator (FI) bits can be added to the RLC header. The RLC/MAC layers subsequently perform multiplexing, wherein the MAC layer chooses traffic from the highest priority to lowest priority radio bearers and generates the packets as defined above with respect to SN compression and concatenation/segmentation, providing the length assigned in the TRB. However, if a radio bearer cannot use the entire length it proceeds to the next radio bearer.

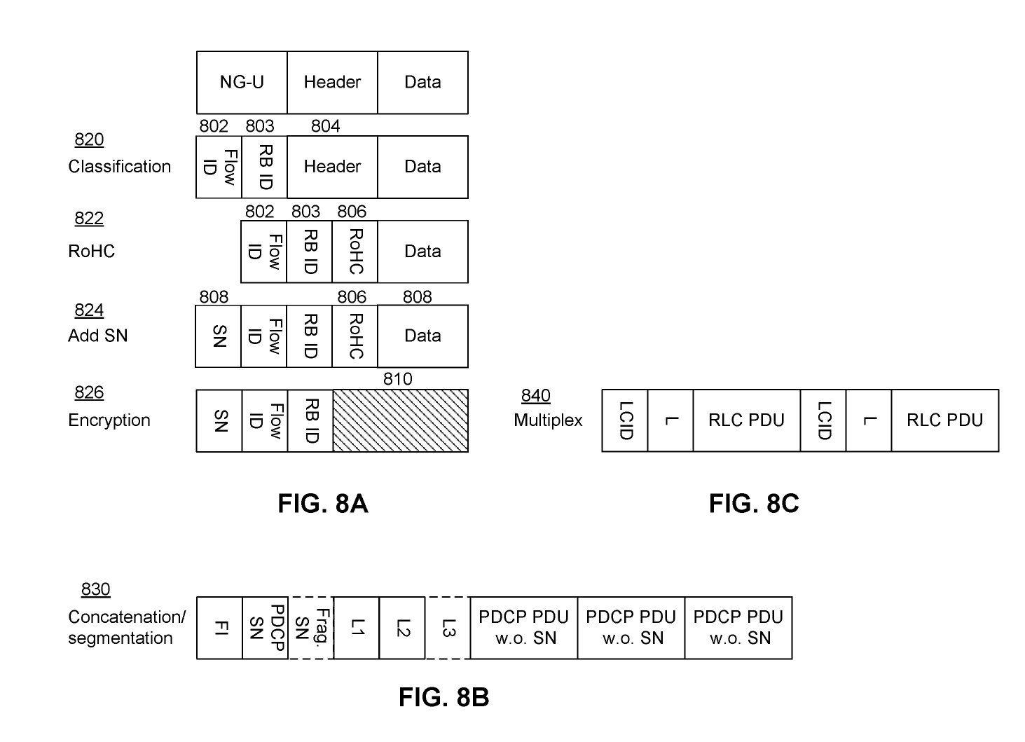

FIGS. 8A, 8B and 8C illustrate a PDCP description, a RLC description and a MAC description, respectively, in accordance with embodiments of the present invention. With reference to FIG. 8A, the PDCP layer performs actions including classification 820, robust header compression (RoHC) 822, addition of a sequence number (SN) 824 and encryption 826. During classification, the PDCP layer classifies the PDCP PDU by flow ID 802 and radio bearer ID (RB ID) 805. During RoHC, the PDCP layer compresses the header 804, resulting the creation of the RoHC 806. The SN 808 is subsequently added and the RoHC 806 and Data 808 are encrypted 810. With reference to FIG. 8B, the RLC layer performs concatenation/segmentation 830. And as illustrated in FIG. 8C, the MAC layer performs multiplexing 840.

According to embodiments, the receiving side protocol is defined as shown in TABLE 2. The MAC layer reads the LCD and L fields and separates the different PDUs for processing by the appropriate RLC entities. The L field is internally passed to upper layers, as well as the TTI. The RLC layer performs reassembly, wherein all fully formed packets are immediately sent to upper layers. The first and last packets may be buffered until they can be reformed. If through merging the PDU is created, forward to PDCP for processing. The RLC layer subsequently performs SN decompression, wherein the PDCP SN is reconstructed from the RLC SN and the number of SDUs within that RLC PDU. The PDCP layer can then perform reordering, wherein a packet is only sent for further processing if all PDCP SN, with matching Flow IDs have been processed already. Internally the PDCP SN is maintained and incremented whenever a new packet is sent for further processing. One Flow ID (for example, flow ID=0) is marked as a flow which does not require in-order delivery and thus packets are always immediately forwarded onwards for this flow ID. The PDCP layer subsequently performs RoHC decompression, wherein there are individual RoHCs per Flow ID. Classification is then performed, wherein based on the Flow ID, RB ID and potentially additional fields (for example network slice ID, or IP addresses) the NG-U header is determined.

TABLE 2

| | | | Header |
|---|---|---|---|
| Step | Info Used | Info. added | Modified |
| 1) DeMultiplex | LCID | DRB ID, L_{T} | Strip LCD, L_{T} |
| 2) Reassembly | FI, RLC SN, | | |
| | Fragment number | | |
| 3) SN | RLC SN | PDCP SN | |
| decompression | | | |
| 4) Decryption | PDPC SN, Flow | | |
| | ID, RB ID | | |
| 5) ReOrdering | PDCP SN, Flow | | |
| | ID, DRB ID | | |
| 6) RoHC | RoHC header, | | Header added |
| | Flow ID, DRB ID | | |
| 7) Classification | Flow ID, DRB ID, | NG-U header | |
| | IP header | | |

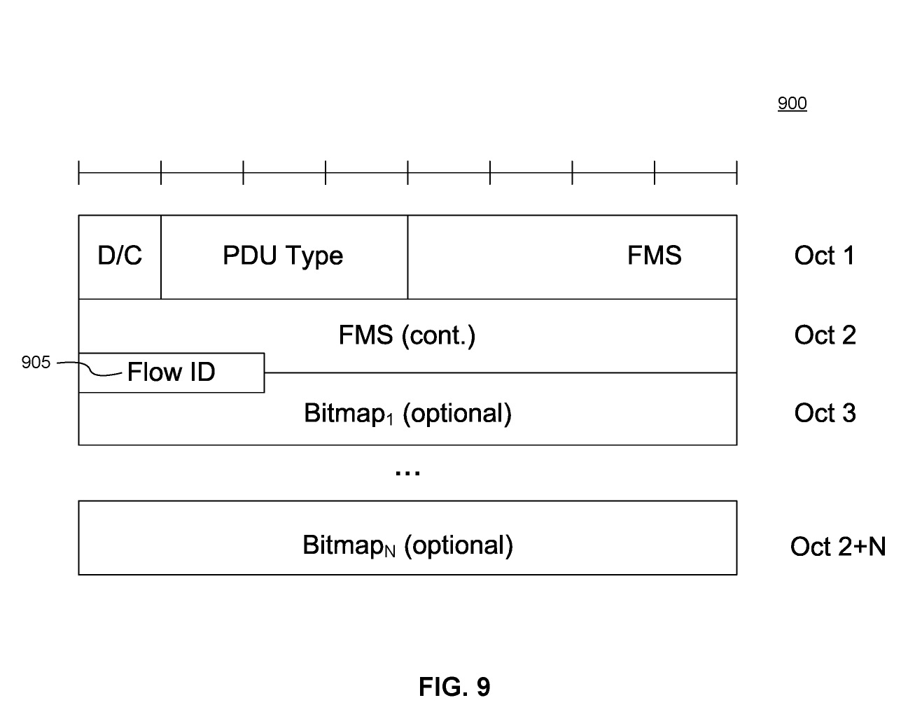

According to embodiments, when flow ID is used for defining the handling of packets for delivery, for example in-order delivery or not-in-order deliver, the feedback relating to the reception of packets will have to include at least a reference to the flow ID. In some embodiments, for RLC layer feedback a flow ID field can be appended to all of the SN fields in the RLC feedback packet. In some embodiments, for the PDCP layer feedback is configured to provide multiple PDCP feedbacks, for example one feedback packet for each flow ID, or SN mapping. A PDCP feedback packet 900 configured in accordance with embodiments of the present invention, is illustrated in FIG. 9. The PDCP feedback packet 900 includes a flow ID field 905.

Those skilled in the art will appreciate that while this discussion is described in relation to interaction between a UE and a radio access node or within a UE or radio access node, it is understood that a radio access node can denote a node, such as a base station or access point, within the radio access network that provides radio access to a UE. In the context of an LTE network, this node may be an eNodeB, while in other networks it may be a NodeB. In the context of next generation networks, this node may be a gNodeB.

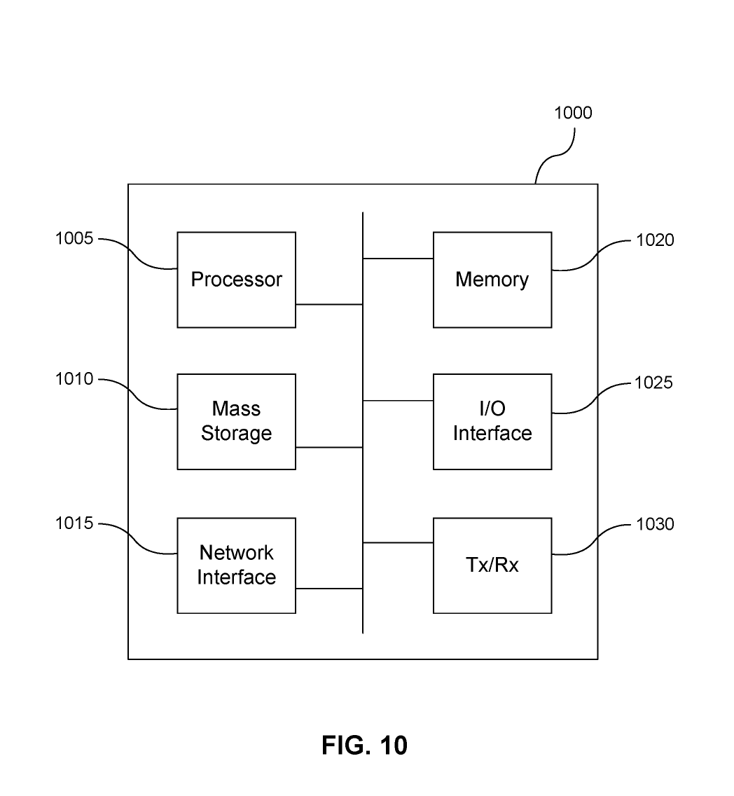

FIG. 10 is a schematic diagram of a hardware device or electronic device 1000 that may for example, comprise nodes or functional entities of the communications system, or perform any or all of steps of the above methods and features described herein, according to different embodiments of the present invention. In some embodiments, the electronic device (ED) or hardware device 1000 may be an element of communications network infrastructure, such as a base station (for example a NodeB, an evolved Node B (eNodeB, or eNB), a next generation NodeB (sometimes referred to as a gNodeB or gNB), a home subscriber server (HSS), a gateway (GW) such as a packet gateway (PGW) or a serving gateway (SGW) or various other nodes or functions within a core network (CN) or a Public Land Mobility Network (PLMN). In other embodiments, the electronic device may be a device that connects to the network infrastructure over a radio interface, such as a mobile phone, smart phone or other such device that may be classified as a User Equipment (UE). In some embodiments, ED may be a Machine Type Communications (MTC) device (also referred to as a machine-to-machine (m2m) device), or another such device that may be categorized as a UE despite not providing a direct service to a user. In some references, an ED may also be referred to as a mobile device, a term intended to reflect devices that connect to mobile network, regardless of whether the device itself is designed for, or capable of, mobility. Specific devices may utilize all of the components shown or only a subset of the components, and levels of integration may vary from device to device. Furthermore, a device may contain multiple instances of a component, such as multiple processors, memories, transmitters, receivers, transceivers etc. As shown, the device includes a processor 1005 such as a Central Processing Unit (CPU), and may further include specialized processors such as a Graphics Processing Unit (GPU) or other such processor, memory 1020, non-transitory mass storage 1010, I/O interface 1025, network interface 1015, and a transceiver 1030, all of which are communicatively coupled via bi-directional bus. According to certain embodiments, any or all of the depicted elements may be utilized, or only a subset of the elements. Further, device may contain multiple instances of certain elements, such as multiple processors, memories, or transceivers. Also, elements of the hardware device may be directly coupled to other elements without the bi-directional bus. The ED may optionally also include a video adapter or other component.

The memory 1020 may include any type of non-transitory memory such as static random access memory (SRAM), dynamic random access memory (DRAM), synchronous DRAM (SDRAM), read-only memory (ROM), any combination of such, or the like. The mass storage element may include any type of non-transitory storage device, such as a solid state drive, hard disk drive, a magnetic disk drive, an optical disk drive, USB drive, or any computer program product configured to store data and machine executable program code. In some embodiments, mass storage may be integrated with a heterogeneous memory. According to certain embodiments, the memory or mass storage may have recorded thereon statements and instructions executable by the processor for performing any of the aforementioned method steps described above.

The electronic device 1000 can include one or more network interfaces 1015, which may include at least one of a wired network interface and a wireless network interface. A network interface may include a wired network interface to connect to a network, and also may include a radio access network interface for connecting to other devices over a radio link. When ED is a network infrastructure element, the radio access network interface may be omitted for nodes or functions acting as elements of the PLMN other than those at the radio edge (e.g. an eNB). When ED is infrastructure at the radio edge of a network, both wired and wireless network interfaces may be included. When ED is a wirelessly connected device, such as a User Equipment, radio access network interface may be present and it may be supplemented by other wireless interfaces such as WiFi network interfaces. The network interfaces allow the electronic device to communicate with remote entities such as those connected to network.

According to embodiments, a video adapter and the I/O interface 1025 provide interfaces to couple the electronic device to external input and output devices. Examples of input and output devices include a display coupled to the video adapter and an I/O device such as a touch-screen coupled to the I/O interface. Other devices may be coupled to the electronic device, and additional or fewer interfaces may be utilized. For example, a serial interface such as Universal Serial Bus (USB) (not shown) may be used to provide an interface for an external device. Those skilled in the art will appreciate that in embodiments in which ED is part of a data center, I/O interface and Video Adapter may be virtualized and provided through network interface.

In some embodiments, electronic device 1000 may be a standalone device, while in other embodiments electronic device may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources may take the form of physical connections such as Ethernet or optical communications links, and in some instances may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created.

It should further be understood that different embodiments have been discussed in the context of individual features or elements. This has been for the sake of simplifying the discussion. Features and elements introduced in one embodiment may be combined with the features and elements introduced in other embodiments. In one non-limiting example provided solely for the purposes of illustration, the identifier is solely indicative of in-order delivery or not in-order delivery and the packet further includes a flow ID, wherein the flow ID is used to is used together with a sequence number in order to determine for evaluation of packet order in instances where the identifier is set to indicate in-order delivery.

According to embodiments of the present invention, there is provided a method for ordering protocol data unit delivery. The method includes inserting an identifier into a header of a packet, wherein the identifier is indicative of in-order packet delivery or out-of order packet delivery and transmitting the packet. In some embodiments, the method further includes inserting a sequence number in the header of the packet, wherein the inserted sequence number is dependent on the identifier.

According to embodiments of the present invention, there is provided a method for ordering protocol data unit delivery. The method includes inserting an flow identifier into a header of a packet, wherein the flow identifier is indicative of in-order packet delivery or out-of order packet delivery and transmitting the packet.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. Moreover, in some instances the present invention has been described using reference to terminology specific to LTE, it is readily understood that the use of these terms is meant to be illustrative and not limiting. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method for ordering protocol data unit (PDU) delivery, the method comprising:
inserting, at a packet data convergence protocol (PDCP) layer in a transmitter, an identifier indicative of out of order delivery into the PDU and
transmitting the PDU by the transmitter.

2. The method according to claim 1, wherein the identifier is inserted into a header of the PDU.

3. The method according to claim 1, wherein the identifier is a flow identifier (flow ID).

4. The method according to claim 3, wherein each flow ID has an associated set of sequence numbers.

5. The method according to claim 3, wherein one flow ID is associated with a plurality of flows requiring out-of-order delivery.

6. The method according to claim 3, further comprising:
mapping the PDU for delivery to at least one particular data radio bearer (DRB), wherein the at least one particular radio bearer is determined at least in part based on the flow ID.

7. The method according to claim 6, wherein the PDU is an uplink packet and wherein mapping the uplink packet for delivery is at least in part dependent on a known mapping of a downlink packet.

8. The method according to claim 6, wherein the PDU is a downlink packet and wherein mapping the downlink packet for delivery is at least in part dependent on a known mapping of an uplink packet.

9. The method according to claim 1, wherein the identifier is a sequence number, wherein a first set of sequence numbers are indicative of in-order delivery and a second set of sequence numbers are indicative of out-of-order delivery.

10. The method according to claim 1, wherein the method further comprises:
inserting, at the PDCP layer of the transmitter, a sequence number into the PDU for delivery, wherein the sequence number is dependent on the identifier.

11. An apparatus for ordering protocol data unit (PDU) delivery, the apparatus comprising:
a processor; and
a memory for storing instructions that when executed by the processor cause the UE to be configured to:
insert an identifier indicative of out-of-order delivery into the PDU; and
transmit the PDU.

12. The apparatus according to claim 11, wherein the identifier is inserted into a header of the PDU.

13. The apparatus according to claim 11, wherein the identifier is a flow identifier (flow ID).

14. The apparatus according to claim 13, wherein each flow ID has an associated set of sequence numbers.

15. The apparatus according to claim 11, wherein the identifier is a sequence number, wherein a first set of sequence numbers are indicative of in-order delivery and a second set of sequence numbers are indicative of out-of-order delivery.

16. The apparatus according to claim 11, wherein the instructions when executed by the processor further cause the apparatus to be configured to:
insert a sequence number into the PDU for delivery, wherein the sequence number is dependent on the identifier.

17. The apparatus according to claim 11, wherein the apparatus is a user equipment, a base station or a core network function.

18. A method for ordering packet data convergence protocol (PDCP) packet delivery, the method comprising:
receiving, by a receiver, a PDCP packet, wherein the PDCP packet includes an identifier; and
in accordance with a check of the identifier, forwarding the PDCP packet to an upper layer when the identifier is set as not in-order delivery.

19. The method according to claim 18, wherein the identifier is a flow identifier (flow ID).

20. The method according to claim 3, wherein each flow ID has an associated set of sequence numbers.

21. An apparatus for ordering packet data convergence protocol (PDCP) delivery, the apparatus comprising:
a processor; and
a memory for storing instructions that when executed by the processor cause the UE to be configured to:
receive a PDCP packet, wherein the PDCP packet includes an identifier; and
in accordance with a check of the identifier, forward the PDCP packet to an upper layer when the identifier is set as not in-order delivery.

22. The apparatus according to claim 21, wherein the identifier is a flow identifier (flow ID).

23. The apparatus according to claim 22, wherein each flow ID has an associated set of sequence numbers.

24. The apparatus according to claim 21, wherein the apparatus is a user equipment, a base station or a core network function.
